(19) United States
(12) Patent Application Publication
(10) Pub. No.: US 2026/0104741 A1
(43) Pub. Date: Apr. 16, 2026

(54) ELECTRONIC DEVICE, METHOD, AND NON-TRANSITORY COMPUTER-READABLE RECORDING MEDIUM FOR SWITCHING SCREENS

(71) Applicant: Samsung Electronics Co., Ltd., Suwon-si (KR)

(72) Inventors: Wonseok RHEE, Suwon-si (KR); Seoghee JEONG, Suwon-si (KR); Seonghoon CHOI, Suwon-si (KR); Jonghwa OH, Suwon-si (KR); Inhyung JUNG, Suwon-si (KR)

(21) Appl. No.: 19/409,101

(22) Filed: Dec. 4, 2025

Related U.S. Application Data
(63) Continuation of application No. PCT/KR2024/007346, filed on May 29, 2024.

(30) Foreign Application Priority Data
Jul. 19, 2023 (KR) 10-2023-0094193
Oct. 23, 2023 (KR) 10-2023-0142485

(51) Int. Cl. G06F 1/16

(52) U.S. Cl. CPC G06F 1/1677; G06F 1/1618; G06F 1/1652

(57) ABSTRACT

An electronic device is provided. The electronic device includes memory storing instructions, when executed by the processor, cause the electronic device to display a cover screen including an image object to represent an application being executed in a background through a sub display, based on receiving an input for selecting the image object, identify a first screen which is sequentially changed from the cover screen by another input, and is located at a designated position with respect to the cover screen among one or more screens for controlling a function being executed through the application, and change the cover screen to the first screen based on that the first screen is identified.

### CROSS-REFERENCE TO RELATED APPLICATION(S)

This application is a continuation application, claiming priority under 35 U.S.C. § 365(c), of an International application No. PCT/KR2024/007346, filed on May 29, 2024, which is based on and claims the benefit of a Korean patent application number 10-2023-0094193, filed on Jul. 19, 2023, in the Korean Intellectual Property Office, and of a Korean patent application number 10-2023-0142485, filed on Oct. 23, 2023, in the Korean Intellectual Property Office, the disclosure of each of which is incorporated by reference herein in its entirety.

### BACKGROUND

### 1. Field

The disclosure relates to an electronic device, a method, and a non-transitory computer-readable recording medium changing a screen.

### 2. Description of Related Art

An electronic device such as a smartphone may include various sensors for providing an improved function and usability to a user. Along with the provision of this function, as a device that combine compactness and portability, for example, a foldable electronic device is being developed.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device, a method, and a non-transitory computer-readable recording medium changing a screen.

Additional aspects will be set forth in part in the description which follows and, in part, will be apparent from the description, or may be learned by practice of the presented embodiments.

In accordance with an aspect of the disclosure, an electronic device is provided. The electronic device includes a housing including a first housing part, and a second housing part which is movably arranged with respect to the first housing part, a flexible display bendable according to relative motion of the second housing part with respect to the first housing part, a sub display included on a second side opposite to a first side of the first housing part on which the flexible display is included, memory storing instructions, and at least one processor including processing circuitry, the at least one processor communicatively coupled to the flexible display, the sub display and the memory, wherein the instructions, when executed by the at least one processor individually or collectively, cause the electronic device to display a cover screen including an image object to represent an application being executed in a background through the sub display, based on receiving an input for selecting the image object, identify a first screen which is sequentially changed from the cover screen by another input, and is located at a designated position with respect to the cover screen, among one or more screens for controlling a function being executed through the application, and change the cover screen to the first screen based on that the first screen is identified.

In accordance with another aspect of the disclosure, a method is provided. The method is performed by an electronic device including a housing including a first housing part, and a second housing part which is movably arranged with respect to the first housing part, a flexible display bendable according to relative motion of the second housing part with respect to the first housing part, and a sub display included on a second side opposite to a first side of the first housing part on which the flexible display is included, the method includes displaying, by the electronic device, a cover screen including an image object to represent an application being executed in a background through the sub display, based on receiving an input for selecting the image object, identifying, by the electronic device, a first screen which is sequentially changed from the cover screen by another input, and is located at a designated position with respect to the cover screen, among one or more screens for controlling a function being executed through the application, and changing, by the electronic device, the cover screen to the first screen based on that the first screen is identified.

In accordance with another aspect of the disclosure, one or more non-transitory computer readable storage media, storing one or more computer programs including computer-executable instructions that, when executed by one or more processors of an electronic device individually or collectively, cause the electronic device to perform operations are provided. The electronic device including a housing including a first housing part, and a second housing part which is movably arranged with respect to the first housing part, a flexible display bendable according to relative motion of the second housing part with respect to the first housing part, and a sub display included on a second side opposite to a first side of the first housing part on which the flexible display is included, the operations include displaying, by the electronic device, a cover screen including an image object to represent an application being executed in a background through the sub display, based on receiving an input for selecting the image object, identifying, by the electronic device, a first screen which is sequentially changed from the cover screen by another input, and is located at a designated position with respect to the cover screen, among one or more screens for controlling a function being executed through the application, and changing, by the electronic device, the cover screen to the first screen based on that the first screen is identified.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment, according to an embodiment of the disclosure;

FIG. 2A illustrates an example of an unfolded state of an electronic device, according to an embodiment of the disclosure;

FIG. 2B illustrates an example of a folded state of an electronic device, according to an embodiment of the disclosure;

FIG. 2C illustrates an example of an intermediate state of an electronic device, according to an embodiment of the disclosure;

FIG. 3 illustrates an example of a screen displayed on a second display of an electronic device according to an embodiment of the disclosure;

FIG. 4A illustrates an example of screens that may be displayed on a second display of an electronic device according to an embodiment of the disclosure;

FIG. 4B illustrates an example of an operation in which a screen displayed on a second display of an electronic device is changed to another screen according to an embodiment of the disclosure;

FIG. 5A illustrates an example of screens that may be displayed on a second display of an electronic device according to an embodiment of the disclosure;

FIG. 5B illustrates an example of an operation in which a screen displayed on a second display of an electronic device is changed to another screen according to an embodiment of the disclosure;

FIG. 6A illustrates an example of screens that may be displayed on a second display as an electronic device is changed from an unfolded state to a folded state according to an embodiment of the disclosure;

FIG. 6B illustrates an example of an operation in which a screen displayed on a second display of an electronic device is changed to another screen according to an embodiment of the disclosure;

FIG. 7 illustrates an example of an operation in which a screen displayed on a second display of an electronic device is changed to another screen according to an embodiment of the disclosure;

FIG. 8 is a flowchart representing an operation performed by an electronic device, according to an embodiment of the disclosure;

FIG. 9 is a flowchart representing an operation performed by an electronic device, according to an embodiment of the disclosure;

FIG. 10 is a flowchart representing an operation performed by an electronic device, according to an embodiment of the disclosure; and

FIG. 11 is a flowchart representing an operation performed by an electronic device, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth™ chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

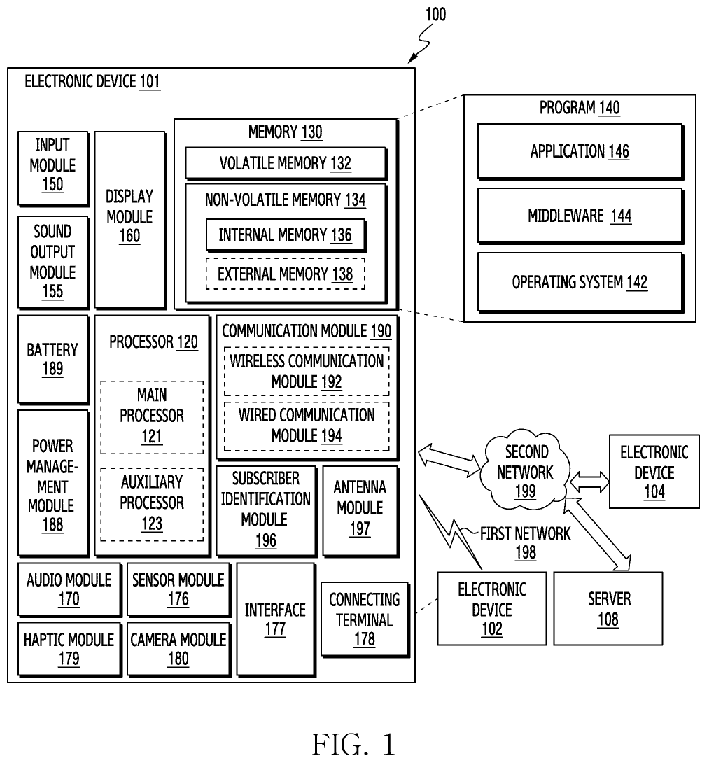

FIG. 1 is a block diagram illustrating an electronic device in a network environment according to an embodiment of the disclosure.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beamforming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

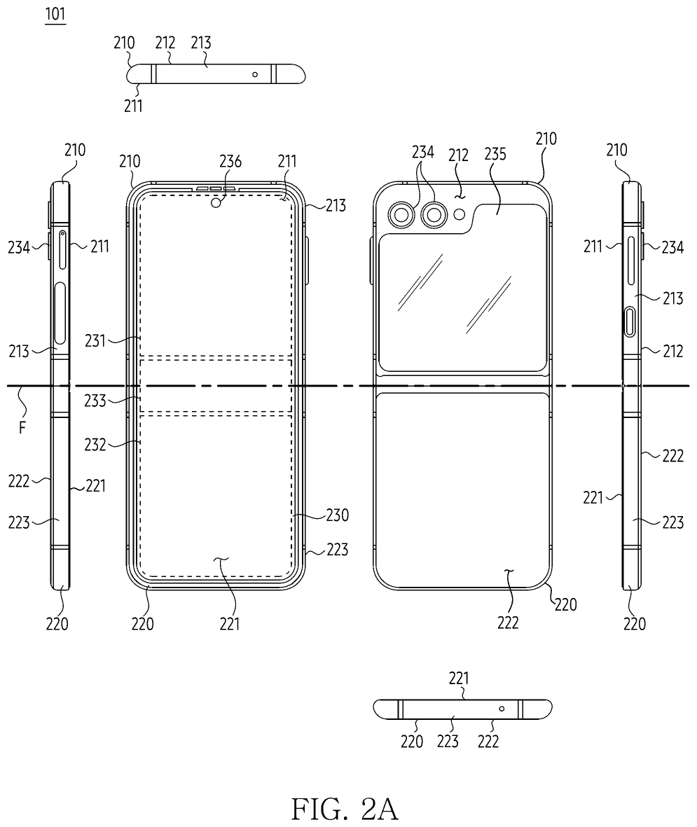

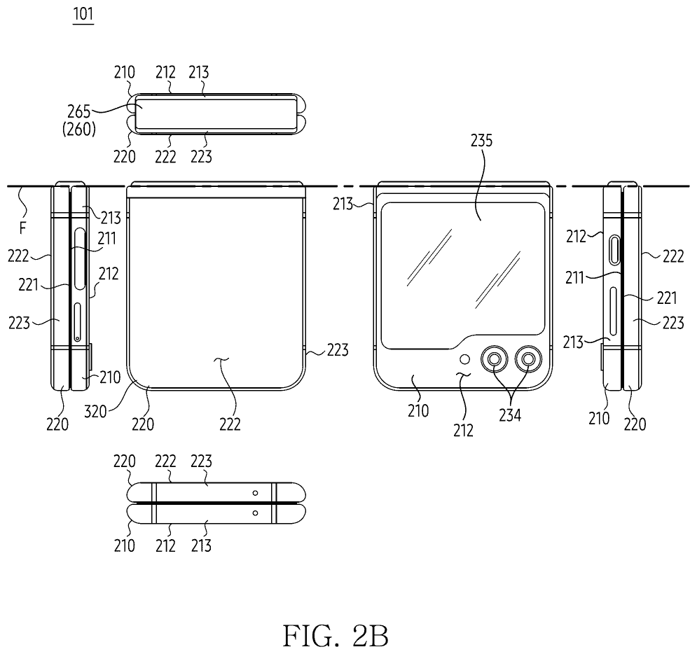

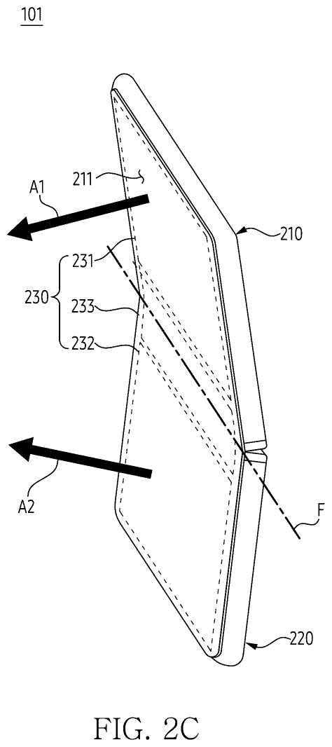

FIG. 2A illustrates an example of an unfolded state of an electronic device, according to an embodiment of the disclosure.

FIG. 2B illustrates an example of a folded state of an electronic device, according to an embodiment of the disclosure.

FIG. 2C illustrates an example of an intermediate state of an electronic device, according to an embodiment of the disclosure.

Referring to FIGS. 2A and 2B, an electronic device 101 may include a first housing 210, a second housing 220, and a hinge structure (or a hinge assembly) 260. In an embodiment, the first housing 210 may be rotatably connected to the hinge structure 260. The first housing 210 may rotate with respect to the second housing 220 through the hinge structure 260. In an embodiment, the second housing 220 may be rotatably connected to the hinge structure 260. The second housing 220 may rotate with respect to the first housing 210 through the hinge structure 260.

In an embodiment, the first housing 210 may include a first side 211, a second side 212 faced away from the first side 211, and a third side 213 covering at least a portion of the first side 211 and the second side 212. In an embodiment, the first housing 210 may provide a space for disposing components of the electronic device 101. In an embodiment, the first housing 210 may include a conductive material, a non-conductive material, or a combination thereof. The first side 211, the second side 212, and the third side 213 of the first housing 210 may be referred to as a front side, a rear side, and a lateral side of the first housing 210, respectively.

In an embodiment, the second housing 220 may include a first side 221, a second side 222 faced away from the first side 221, and a third side 223 covering at least the portion of the first side 221 and the second side 222. In an embodiment, the second housing 220 may provide a space for disposing components of the electronic device 101. The first side 221, the second side 222, and the third side 223 of the second housing 220 may be referred to as a front side, a rear side, and a lateral side of the second housing 220, respectively.

In an embodiment, the hinge structure 260 may be connected to the first housing 210 and the second housing 220, respectively. For example, the hinge structure 260 may include a first hinge plate and a second hinge plate configured to be rotatable. The first hinge plate may be connected to the first housing 210, and the first housing 210 may be rotated by the first hinge plate. The second hinge plate may be connected to the second housing 220, and the second housing 220 may be rotated by the second hinge plate.

According to an embodiment, the electronic device 101 may be folded or unfolded based on a folding axis F passing through the hinge structure 260 according to rotation of the first housing 210 and the second housing 220. The hinge structure 260 may be located between the first housing 210 and the second housing 220 so that the electronic device 101 may be folded based on the folding axis F.

In an embodiment, the hinge structure 260 may include a hinge cover 265 for covering an internal structure (e.g., a hinge mechanism). The hinge cover 265 may be exposed to an outside according to a degree to which the electronic device 101 is folded, or may be covered by the first housing 210 and the second housing 220. For example, while the electronic device 101 is in a folded state (e.g., FIG. 2B), the hinge cover 265 may be at least partially exposed through a space between the first housing 210 and the second housing 220. For example, while the electronic device 101 is in an unfolded state (e.g., FIG. 2A), the hinge cover 265 may be covered by the first housing 210 and the second housing 220.

According to an embodiment, the electronic device 101 may include a first display 230 (e.g., the display module 160 of FIG. 1) disposed in a space provided by the first housing 210 and the second housing 220. For example, the first display 230 may be at least partially accommodated in a recess formed on the first side 211 of the first housing 210 and the first side 221 of the second housing 220. In an embodiment, the first display 230 may include a first flat part 231 aligned with respect to the first housing 210, a second flat part 232 spaced apart from the first flat part 231 and aligned with the second housing 220, and a folding part 233 aligned with respect to the hinge structure 260 and extending from the first flat part 231 to the second flat part 232. The first display 230 may be referred to as a foldable display or a flexible display. The first flat part 231, the second flat part 232, and the folding part 233 may form a surface of the first display 230. The surface of the first display 230 may at least partially form the first side 211 of the first housing 210 and the first side 221 of the second housing 220. The first flat part 231, the second flat part 232, and the folding part 233 may be referred to as a first area, a second area, and a folding area of the first display 230, respectively.

In an embodiment, the electronic device 101 may include a second display 235 (e.g., the display module 160 of FIG. 1) disposed in the first housing 210. The second display 235 may be visible through the second side 212 of the first housing 210.

According to an embodiment, the electronic device 101 may include a plurality of cameras (e.g., the camera module 180 of FIG. 1). For example, the electronic device 101 may include cameras 234 and 236. In an embodiment, the camera 234 may be disposed in the first housing 210 to obtain an image through a portion of the second side 212. In an embodiment, the camera 236 may be disposed under the first flat part 231 of the first display 230. The camera 236 may be aligned with an opening at least partially penetrating the first flat part 231, and may obtain an image through the hole. The camera 236 may be located in a screen display area of the first display 230, but is not limited thereto.

Hereinafter, states of the electronic device 101 will be described with reference to FIGS. 2A, 2B, and 2C. According to an embodiment, the electronic device 101 may include the unfolded state (e.g., FIG. 2A), the folded state (e.g., FIG. 2B), and the intermediate state (e.g., FIG. 2C). The electronic device 101 may vary between the unfolded state and the folded state, and the intermediate state may be a state between the unfolded state and the folded state. In an embodiment, an angle between the first housing 210 and the second housing 220 may vary according to a state of the electronic device 101.

First, referring to FIG. 2A, in the unfolded state, the first housing 210 and the second housing 220 may form a first angle. As a non-limiting example, the first angle may be approximately 180°. The first flat part 231, the second flat part 232, and the folding part 233 of the first display 230 may form a substantially flat surface. A first direction (e.g., a first direction A1 of FIG. 2C) in which the first side 211 (or the first flat part 231) of the first housing 210 faces and a second direction (e.g., a second direction A2 of FIG. 2C) in which the first side 221 (or the second flat part 232) of the second housing 220 faces may face substantially the same direction.

Referring to FIG. 2B, in the folded state of the electronic device 101, the first housing 210 and the second housing 220 may be folded to face each other by rotating based on the folding axis F. The first housing 210 and the second housing 220 may be overlapped with each other to form a second angle smaller than the first angle. As a non-limiting example, the second angle may be approximately 0°. The folding part 233 of the first display 230 may be bent to correspond to the second angle. The first side 211 of the first housing 210 may face the first side 221 of the second housing 220. The first housing 210 and the second housing 220 may at least partially contact each other, but it is not limited thereto. The first direction in which the first side 211 of the first housing 210 faces and the second direction in which the first side 221 of the second housing 220 faces may be opposite to each other. In the folded state, at least a portion of the first display 230 may not be visible outside the electronic device 101, and the second display 235 may be visible outside the electronic device 101.

Referring to FIG. 2C, in the intermediate state, the first housing 210 and the second housing 220 may form a third angle that is smaller than the first angle and greater than the second angle. The folding part 233 of the first display 230 may be bent to correspond to the third angle.

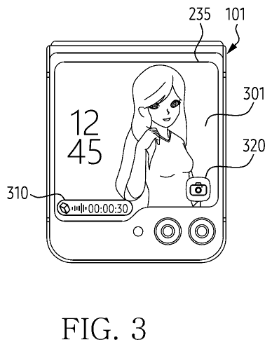

FIG. 3 illustrates an example of a cover screen displayed on a second display of an electronic device according to an embodiment of the disclosure.

FIG. 3 may be described referring to FIGS. 1, 2A, 2B, and 2C.

Referring to FIG. 3, a cover screen 301 may be displayed through a second display 235 in a folded state (e.g., FIG. 2B) and/or an intermediate state (e.g., FIG. 2C) of the electronic device 101. In an embodiment, the cover screen 301 may include at least one image object 310 or 320. In an embodiment, an image object 310 may represent an application being executed in a background. In an embodiment, the image object 310 may display information related to an application being executed in a background. In an embodiment, the image object 310 may also be referred to as a capsule or ongoing activity. In an embodiment, the image object 310 may be related to an application most recently executed in a foreground among one or more applications being executed in the background. In an embodiment, the image object 320 may be a shortcut for executing an application. The capsule may be a user interface (UI) element for providing a continuous notification. In an embodiment, the capsule may be an object for providing a notification (e.g., weather, timewatch, music being played) of an application being executed in the background of the electronic device 101.

In an embodiment, the electronic device 101 may obtain an input of a user to the cover screen 301. In an embodiment, in response to the input of the user to the cover screen 301, the electronic device 101 may display another screen changed from the cover screen 301 on the second display 235. In an embodiment, in response to an input of the user to the second display 235, the electronic device 101 may display a screen among one or more screens which is sequentially arranged from the cover screen 301 on the second display 235. Screens being sequentially arranged from the cover screen 301 may mean that the screens are sequentially displayed on the second display 235 according to a continuous input to the second display 235.

In an embodiment, the electronic device 101 may display another screen adjacent to the cover screen 301 on the second display 235, in response to a swipe input. In an embodiment, in response to the swipe input to the cover screen 301, the screen displayed on the second display 235 may be a widget screen. For example, the widget screen may include a widget of an application. For example, the widget may be a graphic user interface (GUI) for controlling a portion of functions of an application related to the widget and/or displaying information. For example, the widget may be an information widget or a management widget. For example, the widget may be an integrated widget that is a mixture of the information widget and the management widget. The integrated widget may be a widget for providing information and controlling the portion of the functions of the application. However, it is not limited thereto. For example, the information widget may display an information element (e.g., current weather, a currently song information being played) provided by the application related to the widget. For example, the management widget may display a functional element (e.g., next song playback, pause) provided by the application related to the widget. For example, the electronic device 101 may control the portion of functions of the application related to the widget in response to selection of the function element provided by the management widget. For example, the widget may be referred to as a mini-application for the application related to the widget.

In an embodiment, the electronic device 101 may display a screen for the application related to the image object 310 on the second display 235, in response to the tap input to the image object 310. For example, in a case that the application related to the image object 310 is a music application, the electronic device 101 may display a screen for the music application on the second display 235 in response to the tap input to the image object 310. In an embodiment, in response to the tap input to the image object 310 of the cover screen 301, the screen displayed on the second display 235 may be a screen selected from the widget screen or an application screen. For example, the application screen may be a screen generated (or drawn) by an application being executed. For example, the application screen may be a screen for representing an execution result of the application. For example, the application screen may be the GUI for controlling the function of an application related to the image object 310 and/or displaying information.

In an embodiment, in response to the tap input to the image object 320, the electronic device 101 may display the screen for the application related to the image object 320 on the second display 235. For example, in a case that the application related to the image object 320 is a camera application, the electronic device 101 may display an application screen of the camera application on the second display 235, in response to the tap input to the image object 320. In an embodiment, in response to the tap input to the image object 320 of the cover screen 301, the screen displayed on the second display 235 may be the application screen.

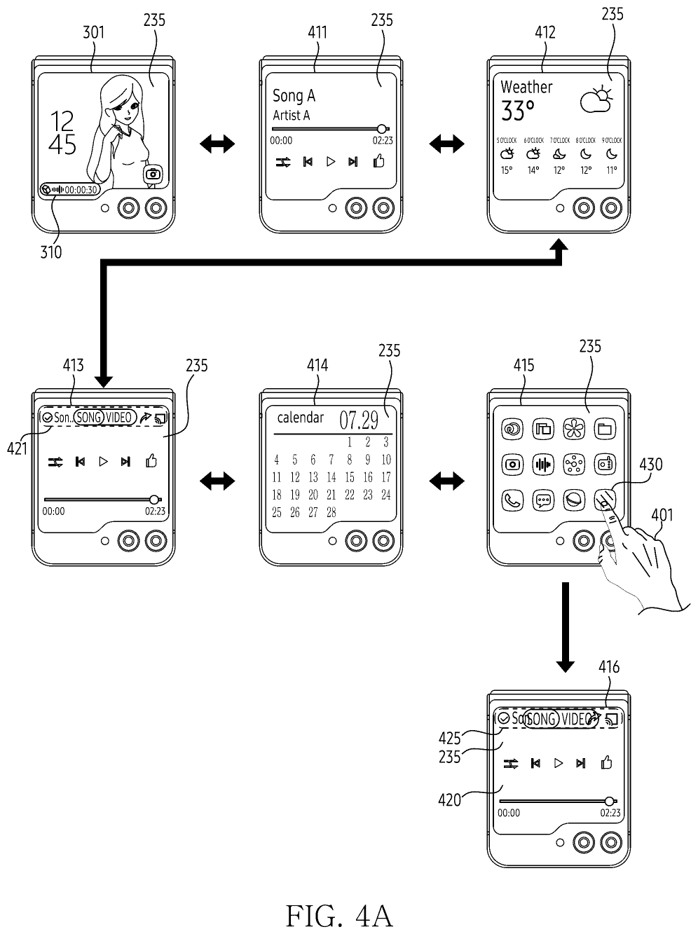

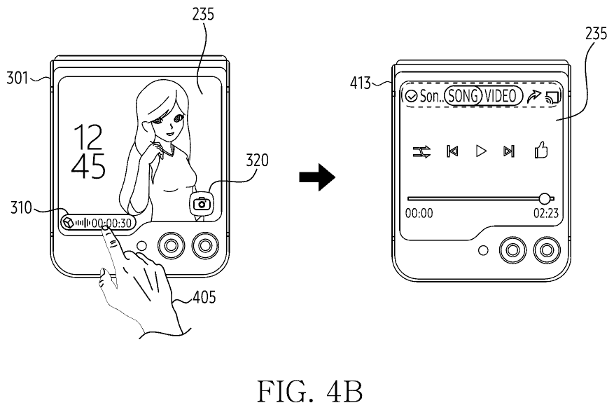

As described above, the electronic device 101 should select a screen to be displayed on the second display 235 among the widget screen or the application screen, in response to the tap input to the image object 310. Accordingly, reaction or satisfaction of the user may vary according to selection of the screen. For example, in a case that a screen that the user does not want is displayed, the user may experience the inconvenience of having to apply an additional input. Accordingly, a method of appropriately selecting a screen to be displayed on the second display 235 among the widget screen or the application screen may be required for the electronic device 101. Hereinafter, an example of an operation in which the electronic device 101 selects a screen to be displayed on the second display 235 will be described with reference to FIGS. 4A, 4B, 5A, 5B, 6A, 6B, and 7.

FIG. 4A illustrates an example of screens that may be displayed on a second display of an electronic device according to an embodiment of the disclosure.

FIG. 4B illustrates an example of an operation in which a screen displayed on a second display of an electronic device is changed to another screen 413 according to an embodiment of the disclosure.

Referring to FIG. 4A, widget screens 411, 412, 413, 414, and 415 may be aligned with respect to a cover screen 301. For example, the control widget screen 411 may be aligned to be adjacent to the cover screen 301 and the widget screen 412. For example, the widget screen 412 may be aligned to be adjacent to the control widget screen 411 and the widget screen 413. For example, the widget screen 413 may be aligned to be adjacent to the widget screen 412 and the widget screen 414. For example, the widget screen 414 may be aligned to be adjacent to the widget screen 413 and an apps widget screen 415. For example, the apps widget screen 415 may be aligned to be adjacent to the widget screen 414. In an embodiment, the widget screens 412, 413, 414, and 415 may be aligned according to a preset alignment order. For example, the widget screens 412, 413, 414, and 415 may be aligned with respect to the cover screen 301 according to an input on a setting screen for aligning the widget screens 412, 413, 414, and 415. For example, the control widget screen 411 may be aligned to be adjacent to the cover screen 301. In an embodiment, the control widget screen 411 may be generated in response to execution of a designated function. For example, the control widget screen 411 may be generated in response to playback of media (e.g., audio).

In an embodiment, the control widget screen 411 may include a widget for controlling the designated function. In an embodiment, the control widget screen 411 may be related to one or more applications providing the designated function (e.g., media playback). For example, in a case that the function (e.g., media playback) designated by the one or more applications is executed, the control widget screen 411 may be generated. For example, in a case that the designated function (e.g., the media playback) is executed by the one or more applications, the control widget screen 411 may control the execution of the designated function. However, it is not limited thereto.

The cover screen 301 or the widget screens 411, 412, 413, 414, and 415 may be sequentially changed by a designated input (e.g., a swipe input). A sequential arrangement of the cover screen 301 or the widget screens 411, 412, 413, 414, and 415 may mean that the cover screen 301 or the widget screens 411, 412, 413, 414, and 415 are sequentially displayed on the second display 235 according to a continuous input to the second display 235.

In an embodiment, in response to the swipe input to the cover screen 301 or the widget screens 411, 412, 413, 414, and 415, the electronic device 101 may change a screen between the cover screen 301 or the widget screens 411, 412, 413, 414, and 415. For example, in response to the swipe input to the control widget screen 411, the electronic device 101 may display the cover screen 301 or the widget screen 412 adjacent to the control widget screen 411 on the second display 235.

In an embodiment, the apps widget screen 415 may include one or more icons for one or more applications that may be executed as a foreground in a folded state (e.g., FIG. 2B) or an intermediate state (e.g., FIG. 2C). For example, one or more icons included in the apps widget screen 415 may be related to one or more applications selected among a plurality of applications installed in the electronic device 101 on the setting screen. The application being executed as the foreground in the folded state (e.g., FIG. 2B) or in the intermediate state (e.g., FIG. 2C) may include a screen generated by the application being executed in the foreground being displayed on the second display 235.

In an embodiment, an application screen 416 may be displayed on the apps widget screen 415 in response to an input (e.g., a tab input) 401 for selecting for an application icon 430 of an application 420. In an embodiment, the application icon 430 may be included in the apps widget screen 415 in a case that the application 420 is set as an application capable of being executed in the foreground.

For example, the application screen 416 may be a screen generated by the application 420 executed in response to the input for selecting for the application icon 430. In an embodiment, in response to the swipe input to the application screen 416, the electronic device 101 may not be changed to the cover screen 301 and/or the widget screens 441, 412, 413, 414, and 415.

Referring to FIG. 4A, user interface (UI) elements may be displayed on the second display 235 without overlapping each other in a navigation area 421 of the widget screen 413. On the other hand, in a navigation area 425 of the application screen 416, a portion of the UI elements may overlap each other and be displayed on the second display 235. This may be a result of changing an environment in which the application screen 416 is rendered from the first display 230 to the second display 235. For example, as the application screen 416 rendered by the electronic device 101 is reduced from the first display 230 to the second display 235, the application screen 416 may also be reduced according to a size of the reduced second display 235. Accordingly, the portion of the UI elements of the application screen 416 displayed on the second display 235 may overlap each other. However, it is not limited to this. For example, content (e.g., an image object, a text object) included in two or more of UI elements of the application screen 416 displayed on the second display 235 may be provided in one UI element (e.g., contents of two or more UI elements may be grouped and provided). For example, the portion of the UI elements of the application screen 416 displayed on the second display 235 may not be provided. For example, the portion of the UI elements may be the UI element selected according to a priority of providing the UI element. The UI element may be a unit UI constituting the application screen 416. For example, each of the texts included in the navigation area 421 of the application screen 416 may be the UI element. For example, each of the image objects (e.g., a play button, a shuffle button, a next button, a previous button) included in the application screen 416 may be the UI element.

In an embodiment, as any one of the screens 411, 413, and 416 is changed to the cover screen 301, the electronic device 101 may display an image object 310 on the cover screen 301. In an embodiment, the electronic device 101 may display the image object 310 for an application related to the screens 411, 413, and 416 on the cover screen 301. However, it is not limited thereto. For example, as the electronic device 101 is changed from an unfolded state (e.g., FIG. 2A) to a folded state (e.g., FIG. 2B) or an intermediate state (e.g., FIG. 2C), the electronic device 101 may display the cover screen 301 including the image object 310. For example, as the electronic device 101 is changed from the unfolded state (e.g., FIG. 2A) to the folded state (e.g., FIG. 2B) or the intermediate state (e.g., FIG. 2C), the electronic device 101 may display the cover screen 301 including the image object 310 for an application executing in the foreground.

In an embodiment, the electronic device 101 may obtain an input (e.g., a tap input) of a user to the image object 310 of the cover screen 301. In an embodiment, the electronic device 101 may obtain the input (e.g., the tap input) to the image object 310 related to the application 420 being executed in a background. In an embodiment, the electronic device 101 may obtain the input (e.g., the tab input) to the image object 310 related to the application 420 most recently executed in the foreground among one or more applications being executed in the background.

In an embodiment, the electronic device 101 may identify the screens 411, 413, and 416 related to the application 420, in response to the input (e.g., the tab input) to the image object 310.

In an embodiment, in response to an input (e.g., the tab input) to the image object 310, the electronic device 101 may display one of the screens 411, 413, and 416 related to the application 420 on the second display 235. In an embodiment, the electronic device 101 may display a screen selected based on a priority between the screens 411, 413, and 416 on the second display 235. In an embodiment, the priority may be set based on the number of the inputs required for changing a screen to one or more screens 411, 413, and 416 related to control of a function being executed through the application 420. For example, as the number of the inputs required is higher, the priority of the screen may be higher. However, it is not limited thereto. For example, the priority may be set based on the number of the inputs and a type of a screen required for changing the screen to the one or more screens 411, 413, and 416 related to the control of the function being executed through the application 420. For example, the priority of a screen in which the number of required inputs is greater than or equal to the reference number, may be higher than the priority of a screen in which the number of required inputs is less than the reference number. For example, in a case of screens in which the number of required inputs is greater than or equal to the reference number, the priority of a designated type of a screen may be higher than a screen of a type other than the designated type. The designated type of the screen may include the widget screen 413 for the application 420. The designated type of the screen may include a screen set to be displayed on the second display 235. However, it is not limited thereto. For example, the designated type of the screen may include the application screen 416.

In an embodiment, the electronic device 101 may identify the screen to be displayed on the second display 235, based on the number of the inputs required for changing the screen to the one or more screens 411, 413, and 416 related to the control of the function being executed through the application 420. According to an embodiment, the number of the inputs required for changing the screen from the cover screen 301 may also be referred to as a distance from the cover screen 301.

In an embodiment, the electronic device 101 may identify the screens 413 and 416 in which the input required to be changed from the cover screen 301 is required greater than or equal to the reference number (e.g., twice) among the one or more screens 411, 413, and 416. In an embodiment, the electronic device 101 may identify the screens 413 and 416 not adjacent to the cover screen 301 among the one or more screens 411, 413, and 416. In an embodiment, the electronic device 101 may determine the designated type of the screen among the identified screens 413 and 416 as a screen to be displayed on the second display 235.

In an embodiment, in response to the input (e.g., the tab input) to the image object 310, the electronic device 101 may display, on the second display 235, the screen 413 which is the designated type of the screen among the screens 413 and 416 in which the input required for changing is required greater than or equal to the reference number (e.g., twice). In an embodiment, the electronic device 101 may display, on the second display 235, the screen 413 which is the designated type of the screen among the screens 413 and 416 not adjacent to the cover screen 301 in response to the input (e.g., the tab input) to the image object 310.

In an embodiment, in a case that there is no the designated type of the screen among the screens 413 and 416 in which the input required to be changed from the cover screen 301 among the one or more screens 411, 413, and 416 is required greater than or equal to the reference number (e.g., twice), the electronic device 101 may determine a screen of a different type from the designated type as a screen to be displayed on the second display 235. In an embodiment, in a case that there is no designated type screen among the screens 413 and 416 not adjacent to the cover screen 301 among the one or more screens 411, 413, and 416, the electronic device 101 may determine a screen of a type different from the designated type as a screen to be displayed on the second display 235. For example, in a case that there is no widget screen 413, the electronic device 101 may determine the application screen 416 as a screen to be displayed on the second display 235.

In an embodiment, in a case that there are no screens 413 and 416 in which the input required to be changed from the cover screen 301 is required greater than or equal to the reference number (e.g., twice) among the one or more screens 411, 413, and 416, the electronic device 101 may determine the screen 411 in which the input required to be changed from the cover screen 301 is required less than the reference number (e.g., twice) as a screen to be displayed on the second display 235 among the one or more screens 411, 413, and 416. In an embodiment, in a case that there are no the screens 413 and 416 not adjacent to the cover screen 301 among the one or more screens 411, 413, and 416, the electronic device 101 may determine a screen adjacent to the cover screen 301 among the one or more screens 411, 413, and 416 as a screen to be displayed on the second display 235. For example, in a case that there are no screens 413 and 416, the electronic device 101 may determine the control widget screen 411 as a screen to be displayed on the second display 235.

Referring to FIG. 4B, in response to a user input 405 with respect to the image object 310 of the cover screen 301, the electronic device 101 may display the widget screen 413 among the one or more screens 411, 413, and 416.

In FIGS. 4A and 4B, the media-related application 420 has been described, but is not limited thereto. For example, operations described through FIGS. 4A and 4B may also be applied to an audio recording application, a stopwatch application, and/or a timer application. For example, based on the input (e.g., the tab input) to the image object 310 of the cover screen 301, a screen may be selected according to a priority among the control widget screen 411, the widget screen, and/or the application screen, and the selected screen may be displayed on the second display 235.

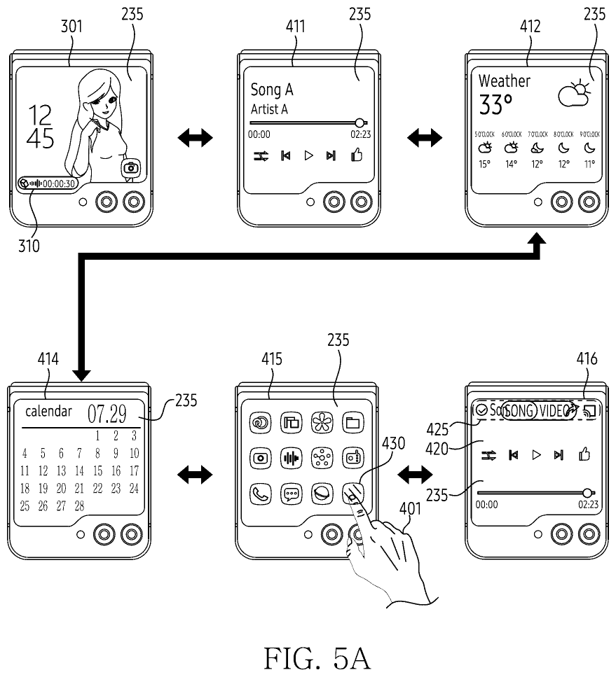

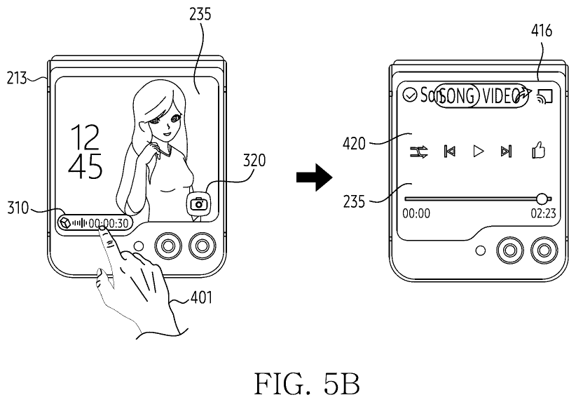

FIG. 5A illustrates an example of screens that may be displayed on a second display of an electronic device according to an embodiment of the disclosure.

FIG. 5B illustrates an example of an operation in which a screen displayed on a second display of an electronic device is changed to another screen according to an embodiment of the disclosure.

Referring to FIG. 5A, widget screens 411, 412, 414, and 415 may be aligned with respect to a cover screen 301. Compared with FIG. 4A, in FIG. 5A, a widget screen 413 may not be displayed on the second display 235. For example, the electronic device 101 may exclude the widget screen 413 from a widget screen to be displayed on the second display 235 according to an input on a setting screen that may select the widget screen to be displayed on the second display 235.

In an embodiment, the control widget screen 411 may be aligned to be adjacent to the cover screen 301 and the widget screen 412. For example, the widget screen 412 may be aligned to be adjacent to the control widget screen 411 and the widget screen 414. For example, the widget screen 414 may be aligned to be adjacent to the widget screen 412 and the apps widget screen 415. The apps widget screen 415 may be aligned to be adjacent to the widget screen 414. In an embodiment, the widget screens 412, 414, and 415 may be aligned according to a preset alignment order. For example, the widget screens 412, 414, and 415 may be aligned with respect to the cover screen 301 according to an input on a setting screen for aligning the widget screens 412, 414, and 415. For example, the control widget screen 411 may be aligned to be adjacent to the cover screen 301. In an embodiment, the control widget screen 411 may be generated in response to execution of a designated function. For example, the control widget screen 411 may be generated in response to playback of media (e.g., audio). However, it is not limited thereto.

The cover screen 301 or the widget screens 411, 412, 414, and 415 may be sequentially changed by a designated input (e.g., a swipe input). A sequential arrangement of the cover screen 301 or the widget screens 411, 412, 414, and 415 may mean that the cover screen 301 or the widget screens 411, 412, 414, and 415 are sequentially displayed on the second display 235 according to a continuous input to the second display 235.

In an embodiment, in response to the swipe input to the cover screen 301 or the widget screens 411, 412, 414, and 415, the electronic device 101 may change a screen between the cover screen 301 or the widget screens 411, 412, 414, and 415. For example, in response to the swipe input to the control widget screen 411, the electronic device 101 may display the cover screen 301 or the widget screen 412 adjacent to the control widget screen 411 on the second display 235.

In an embodiment, an application screen 416 may be displayed on the apps widget screen 415 in response to an input (e.g., a tab input) 401 for selecting for an application icon. For example, the application screen 416 may be a screen generated by an application executed in response to the input for selecting for the application icon. In an embodiment, in response to the swipe input to the application screen 416, the electronic device 101 may not be changed to the cover screen 301 and/or the widget screens 441, 412, 414, and 415.

In an embodiment, as any one of the screens 411 and 416 is changed to the cover screen 301, the electronic device 101 may display an image object 310 on the cover screen 301. In an embodiment, the electronic device 101 may display the image object 310 for an application related to the screens 411 and 416 on the cover screen 301. However, it is not limited thereto. For example, as the electronic device 101 is changed from an unfolded state (e.g., FIG. 2A) to a folded state (e.g., FIG. 2B) or an intermediate state (e.g., FIG. 2C), the electronic device 101 may display the cover screen 301 including the image object 310. For example, as the electronic device 101 is changed from the unfolded state (e.g., FIG. 2A) to the folded state (e.g., FIG. 2B) or the intermediate state (e.g., FIG. 2C), the electronic device 101 may display the cover screen 301 including the image object 310 for an application being executed in a foreground.

In an embodiment, the electronic device 101 may obtain an input (e.g., the tap input) of a user to the image object 310 of the cover screen 301. In an embodiment, the electronic device 101 may obtain the input (e.g., the tap input) to the image object 310 related to an application being executed in a background. In an embodiment, the electronic device 101 may obtain the input (e.g., the tab input) to the image object 310 related to the application most recently executed in the foreground among one or more applications being executed in the background.

In an embodiment, in response to an input (e.g., the tab input) to the image object 310, the electronic device 101 may display one of the screens 411 and 416 related to the application on the second display 235. In an embodiment, the electronic device 101 may display a screen selected based on a priority between the screens 411 and 416 on the second display 235. In an embodiment, the priority may be set based on the number of inputs required for changing a screen to one or more screens 411 and 416 related to control of a function being executed through the application. For example, as the number of the inputs required is higher, the priority of the screen may be higher. However, it is not limited thereto. For example, the priority may be set based on the number of the inputs required for changing the screen and a type of a screen to the one or more screens 411 and 416 related to the control of the function being executed through the application. For example, the priority of a screen in which the number of required inputs is greater than or equal to the reference number, may be higher than the priority of a screen in which the number of required inputs is less than the reference number. For example, in a case of screens in which the number of required inputs is greater than or equal to the reference number, the priority of a designated type of a screen may be higher than a priority of a screen of a type other than the designated type. The designated type of the screen may include the widget screen for the application. The designated type of the screen may include a screen set to be displayed on the second display 235. However, it is not limited thereto. For example, the designated type of the screen may include the application screen.

In an embodiment, the electronic device 101 may identify the screen to be displayed on the second display 23, based on the number of the inputs required for changing the screen to the one or more screens 411 and 416 related to the control of the function being executed through the application. According to an embodiment, the number of the inputs required for changing the screen from the cover screen 301 may also be referred to as a distance from the cover screen 301.

In an embodiment, the electronic device 101 may identify the application screen 416 in which the input required to be changed from the cover screen 301 among the one or more screens 411 and 416 is required greater than or equal to the reference number (e.g., twice). In an embodiment, the electronic device 101 may identify the application screen 416 not adjacent to the cover screen 301 among the one or more screens 411 and 416. In an embodiment, the electronic device 101 may determine the identified application screen 416 as a screen to be displayed on the second display 235.

In an embodiment, in a case that there is no application screen 416 in which the input required to be changed from the cover screen 301 among the one or more screens 411 and 416 is required greater than or equal to the reference number (e.g., twice), the electronic device 101 may determine the control widget screen 411 among the one or more screens 411 and 416 in which the input required to be changed from the cover screen 301 is required less than the reference number (e.g., twice) as a screen to be displayed on the second display 235. In an embodiment, in a case that there is no application 416 not adjacent to the cover screen 301 among the one or more screens 411 and 416, the electronic device 101 may determine the control widget screen 411 adjacent to the cover screen 301 among the one or more screens 411 and 416 as a screen to be displayed on the second display 235. For example, in a case that there is no application 416, the electronic device 101 may determine the control widget screen 411 as a screen to be displayed on the second display 235.

Referring to FIG. 5B, in response to a user input 405 with respect to the image object 310 of the cover screen 301, the electronic device 101 may display the application screen 416 among the one or more screens 411 and 416.

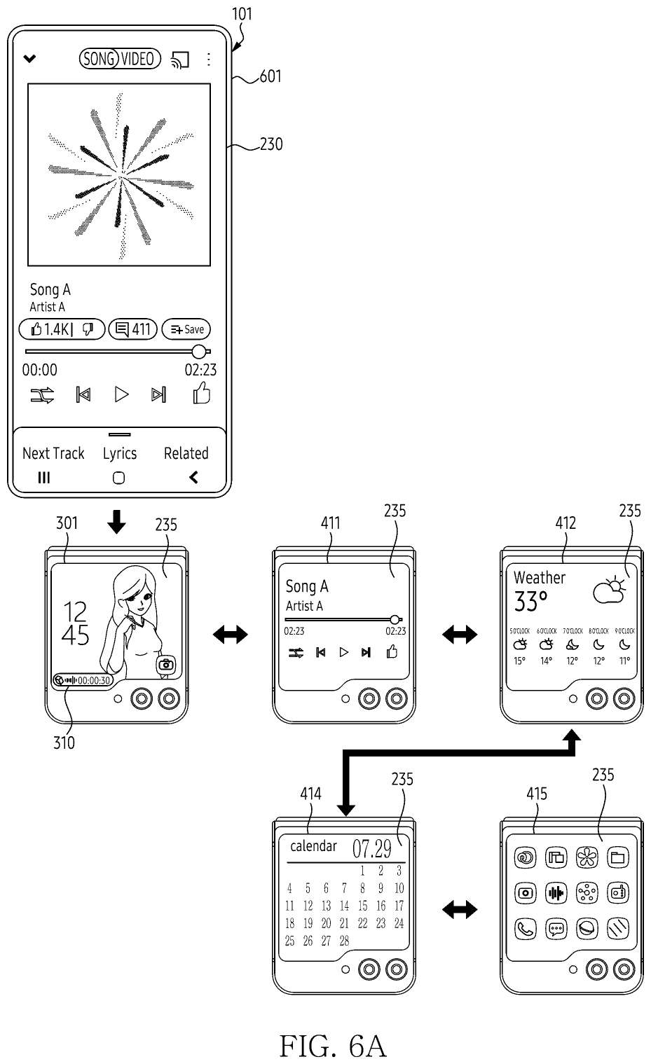

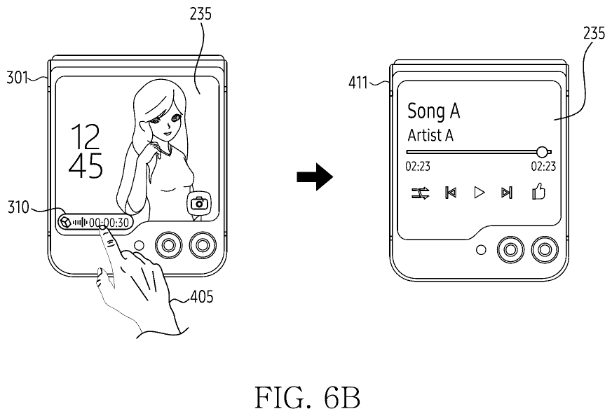

FIG. 6A illustrates an example of screens that may be displayed on a second display as an electronic device is changed from an unfolded state to a folded state according to an embodiment of the disclosure.

FIG. 6B illustrates an example of an operation in which a screen displayed on a second display of an electronic device is changed to another screen 411 according to an embodiment of the disclosure.

Referring to FIG. 6A, widget screens 411, 412, 414, and 415 may be aligned with respect to a cover screen 301. Compared with FIG. 4A, in FIG. 6A, a widget screen 413 may not be displayed on the second display 235. For example, the electronic device 101 may exclude the widget screen 413 from a widget screen to be displayed on the second display 235 according to an input on a setting screen that may select the widget screen to be displayed on the second display 235. Compared with FIG. 4A, in FIG. 6A, an icon 430 of an application 420 may not be displayed on an apps widget screen 415. For example, according to an input on a setting screen that may select an application to be executed in a foreground through the second display 235, the electronic device 101 may exclude the application 420 from the application to be executed in the foreground through the second display 235. For example, as the application 420 is excluded from the application to be executed in the foreground through the second display 235, the electronic device 101 may not display the icon 430 of the application 420 on the apps widget screen 415. The application 420 being excluded from the application to be executed in the foreground through the second display 235 may mean that an application screen 416 of the application 420 is not displayed through the second display 235. The application 420 being excluded from the application to be executed in the foreground through the second display 235 may mean that the application 420 is executed only in a background other than the foreground while the second display 235 is turned on.

In an embodiment, as the electronic device 101 is changed from an application screen 601 to the cover screen 301, the electronic device 101 may display an image object 310 on the cover screen 301. In an embodiment, the electronic device 101 may display the image object 310 for the application 420 on the cover screen 301.

Referring to FIG. 6A, while in the unfolded state (e.g., FIG. 2A), the application screen 601 of the application 420 may be displayed through a first display 230. While displaying the application screen 601 through the first display 230, the electronic device 101 may transition from the unfolded state (e.g., FIG. 2A) to the folded state (e.g., FIG. 2B) or an intermediate state (e.g., FIG. 2C). As the electronic device 101 is transitioned to the folded state (e.g., FIG. 2B) or the intermediate state (e.g., FIG. 2C), the electronic device 101 may turn on the second display 235. As the electronic device 101 is transitioned to the folded state (e.g., FIG. 2B) or the intermediate state (e.g., FIG. 2C), the electronic device 101 may turn off the first display 230 and turn on the second display 235. As the second display 235 is turned on, the electronic device 101 may display a screen on the second display 235. In an embodiment, the electronic device 101 may display the cover screen 301 on the second display 235.

In an embodiment, as the application screen 416 of the application 420 is set not to be displayed on the second display 235, the electronic device 101 may display the cover screen 301 on the second display 235.

In an embodiment, the widget screens 411, 412, 414, and 415 may be aligned with respect to the cover screen 301. In an embodiment, a control widget screen 411 may be aligned to be adjacent to the cover screen 301 and the widget screen 412. For example, the widget screen 412 may be aligned to be adjacent to the control widget screen 411 and the widget screen 414. For example, the widget screen 414 may be aligned to be adjacent to the widget screen 412 and the apps widget screen 415. The apps widget screen 415 may be aligned to be adjacent to the widget screen 414. In an embodiment, the widget screens 412, 414, and 415 may be aligned according to a preset alignment order. For example, the widget screens 412, 414, and 415 may be aligned with respect to the cover screen 301 according to an input on a setting screen for aligning the widget screens 412, 414, and 415. For example, the control widget screen 411 may be aligned to be adjacent to the cover screen 301. In an embodiment, the control widget screen 411 may be generated in response to execution of a designated function. For example, the control widget screen 411 may be generated in response to playback of media (e.g., audio). However, it is not limited thereto.

The cover screen 301 or the widget screens 411, 412, 414, and 415 may be sequentially changed by a designated input (e.g., a swipe input). A sequential arrangement of the cover screen 301 or the widget screens 411, 412, 414, and 415 may mean that the cover screen 301 or the widget screens 411, 412, 414, and 415 are sequentially displayed on the second display 235 according to a continuous input to the second display 235.

In an embodiment, in response to the swipe input to the cover screen 301 or the widget screens 411, 412, 414, and 415, the electronic device 101 may change a screen between the cover screen 301 or the widget screens 411, 412, 414, and 415. For example, in response to the swipe input to the control widget screen 411, the electronic device 101 may display the cover screen 301 or the widget screen 412 adjacent to the control widget screen 411 on the second display 235.

In an embodiment, the electronic device 101 may obtain an input (e.g., a tap input) of a user to the image object 310 of the cover screen 301. In an embodiment, the electronic device 101 may obtain the input (e.g., the tap input) to the image object 310 related to an application being executed in the background. In an embodiment, the electronic device 101 may obtain the input (e.g., the tab input) to the image object 310 related to an application most recently executed in the foreground among one or more applications being executed in the background.

In an embodiment, in response to the input (e.g., the tap input) to the image object 310, the electronic device 101 may display the control widget screen 411 related to an application on the second display 235. In an embodiment, the electronic device 101 may display the control widget screen 411 related to control of a function being executed through the application on the second display 235.

In an embodiment, in a case that there is no control widget screen 411, the electronic device 101 may ignore the input (e.g., the tab input) to the image object 310. Ignoring the input (e.g., the tab input) to the image object 310 may mean not changing from the cover screen 301 to another screen.

Referring to FIG. 6B, in response to a user input 405 to the image object 310 of the cover screen 301, the electronic device 101 may display the control widget screen 411.

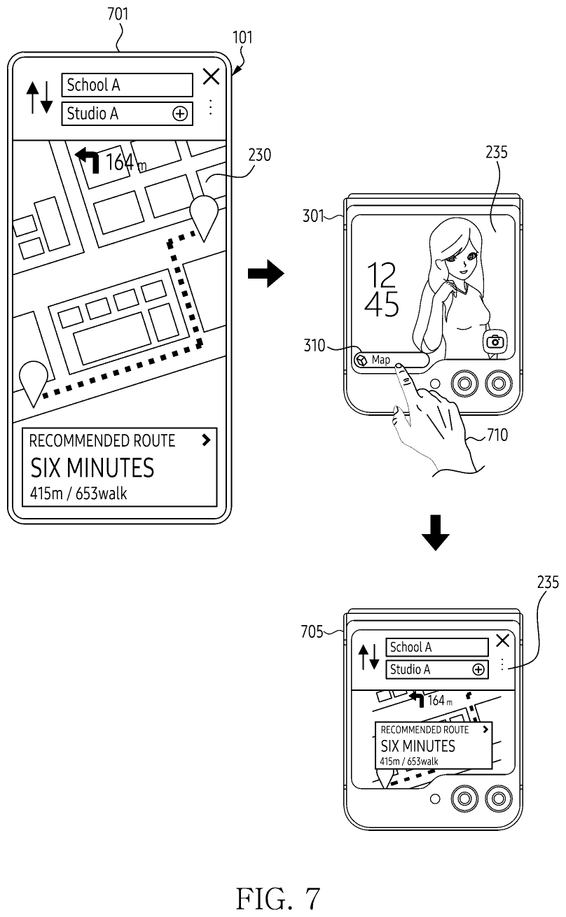

FIG. 7 illustrates an example of an operation in which a screen displayed on a second display of an electronic device is changed to another screen according to an embodiment of the disclosure.

A map application generating an application screen 701 of FIG. 7 may not be related to a control widget screen 411. For example, one or more functions provided by the map application may not be controlled through the control widget screen 411. For example, in response to that the one or more functions of the map application is executed, the control widget screen 411 may not be generated. However, it is not limited thereto.

Referring to FIG. 7, while in an unfolded state (e.g., FIG. 2A), the application screen 701 may be displayed through a first display 230. While displaying the application screen 601 through the first display 230, the electronic device 101 may transition from the unfolded state (e.g., FIG. 2A) to a folded state (e.g., FIG. 2B) or an intermediate state (e.g., FIG. 2C). As the electronic device 101 is transitioned to the folded state (e.g., FIG. 2B) or the intermediate state (e.g., FIG. 2C), the electronic device 101 may turn on the second display 235. As the electronic device 101 is transitioned to the folded state (e.g., FIG. 2B) or the intermediate state (e.g., FIG. 2C), the electronic device 101 may turn off the first display 230 and turn on the second display 235. As the second display 235 is turned on, the electronic device 101 may display a screen on the second display 235. In an embodiment, the electronic device 101 may display a cover screen 301 on the second display 235. In FIG. 7, when a user looks at first sides 211 and 221 of the electronic device 101, as the first side 211 of a first housing 210 rotates toward the first side 221 of a second housing 220, a situation in which the electronic device 101 displays the cover screen 301 on the second display 235 is exemplified, but this is only an example. For example, when the user looks at second sides 212 and 222 of the electronic device 101, the electronic device 101 may display the cover screen 301 on the second display 235 even in a case that the first side 211 of the first housing 210 rotates toward the first side 221 of the second housing 220. In this case, unlike FIG. 7, the second display 235 shown to the user may be inverted up and down, and the cover screen 301 may also be displayed on the second display 235 by being inverted up and down. In addition, even in a case of the unfolded state (e.g., FIG. 2A), the electronic device 101 may display the cover screen 301 on the second display 235. For example, when the electronic device 101 is in the unfolded state (e.g., FIG. 2A), when a state that the second sides 212 and 222 of the electronic device 101 are placed on the floor is change to a state that the first sides 211 and 221 are placed on the floor, by the electronic device 101 being turned over by approximately 180°, the cover screen 301 may be displayed on the second display 235. Even in this case, unlike FIG. 7, the second display 235 and the cover screen 301 of the second display 235 shown to the user may be displayed by a top and a bottom being inverted.

In an embodiment, the electronic device 101 may obtain an input (e.g., a tab input) 710 of the user to an image object 310 of the cover screen 301. In an embodiment, the electronic device 101 may obtain the input 710 to the image object 310 related to the map application being executed in a background. In an embodiment, the electronic device 101 may obtain the input 710 to the image object 310 related to the map application most recently executed in a foreground among one or more applications being executed in the background.

In an embodiment, in response to the input 710 to the image object 310, the electronic device 101 may display a screen 705 of screens related to the map application on the second display 235. As the map application is not related to the control widget screen 411, the screens related to the map application may not include the control widget screen 411.

In an embodiment, the electronic device 101 may display a screen selected based on the priority between screens related to the map application on the second display 235. For example, in a case that there is no widget screen related to the map application, the electronic device 101 may display the application screen 705 of the map application on the second display 235.

Although the map application has been described in FIG. 7, it is not limited to the map application. The operation of FIG. 7 may also be applied to various applications which may generate an application screen that may be displayed through the second display 235. For example, in a case of an application that is set to be executable in the foreground through the second display 235 and in which there are no control widget screen 411 and the widget screen, the electronic device 101 may display the application screen, based on the input (e.g., the tab input) to the image object 310 of the cover screen 301.

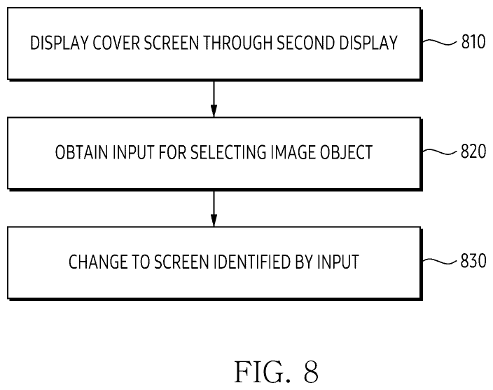

FIG. 8 is a flowchart representing an operation performed by an electronic device, according to an embodiment of the disclosure.

FIG. 8 may be described with reference to FIGS. 1, 2A, 2B, 2C, 3, 4A, 4B, 5A, 5B, 6A, 6B, and 7.

Referring to FIG. 8, in operation 810, the electronic device 101 may display a cover screen 301 through a second display 235. The electronic device 101 may display the cover screen 301 through the second display 235 in a folded state (e.g., FIG. 2B) and/or an intermediate state (e.g., FIG. 2C) of the electronic device 101. In an embodiment, the cover screen 301 may include an image object 310. In an embodiment, the image object 310 may represent an application being executed in a background. In an embodiment, the image object 310 may display information related to the application being executed in the background. In an embodiment, the image object 310 may also be referred to as a capsule or ongoing activity. In an embodiment, the image object 310 may be related to an application most recently executed in a foreground among one or more applications being executed in the background.

In an embodiment, the electronic device 101 may be changed from an application screen 601 to the cover screen 301 including the image object 310. In an embodiment, the electronic device 101 may display the application screen 601 through a first display 230 while it is in an unfolded state (e.g., FIG. 2A). In an embodiment, as the electronic device 101 transitions from the unfolded state (e.g., FIG. 2A) to the folded state (e.g., FIG. 2B) or the intermediate state (e.g., FIG. 2C), the electronic device 101 may turn off the first display 230 and turn on the second display 235. In an embodiment, as the electronic device 101 is transitioned to the folded state (e.g., FIG. 2B) or the intermediate state (e.g., FIG. 2C), the electronic device 101 may display the cover screen 301 on the turned-on second display 235.

In an embodiment, the electronic device 101 may be changed from screens 411, 412, 413, 414, 415, and 416 to the cover screen 301 including the image object 310. In an embodiment, the electronic device 101 may change a screen displayed through the second display 235 from the screens 411, 412, 413, 414, 415, and 416 to the cover screen 301. For example, the electronic device 101 may change the screen displayed through the second display 235 from the screens 411, 412, 413, 414, 415, and 416 to the cover screen 301 in response to an input (e.g., input for selection of a home button on a navigation bar). However, it is not limited thereto. In an embodiment, as the screen is changed from a screen among the screens 411, 413, and 416 to the cover screen 301, the electronic device 101 may display the cover screen 301 including the image object 310.

In operation 820, the electronic device 101 may obtain an input 405 for selecting the image object 310. In an embodiment, the electronic device 101 may obtain a tap input 405 to the image object 310. In an embodiment, the electronic device 101 may obtain the input (e.g., the tap input) 405 to the image object 310 related to an application 420 being executed in a background. In an embodiment, the electronic device 101 may obtain the input (e.g., the tab input) 405 to the image object 310 related to the application 420 most recently executed in the foreground among the one or more applications being executed in the background.

In operation 830, the electronic device 101 may be changed to a screen identified by the input 405. In an embodiment, in response to the input 405 to the image object 310, the electronic device 101 may display the screens 411, 413, and 416 related to the application 420 from the screen 301 on the second display 235. In an embodiment, in a case that there are two or more screens 411, 413, and 416 related to the application 420, the electronic device 101 may display a screen selected based on a priority between the screens 411, 413, and 416 on the second display 235. In an embodiment, the priority may be set based on the number of the inputs required for changing a screen to one or more screens 411, 413, and 416 related to control of a function being executed through the application 420. However, it is not limited thereto. For example, among the screens 411, 413, and 416 related to the application 420, the priority of the recently displayed screen may be high.

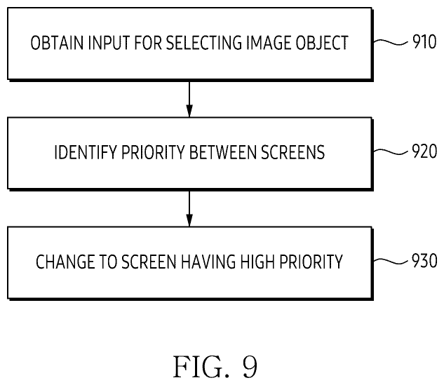

FIG. 9 is a flowchart representing an operation performed by an electronic device, according to an embodiment of the disclosure.

FIG. 9 may be described with reference to FIGS. 1, 2A, 2B, 2C, 3, 4A, 4B, 5A, 5B, 6A, 6B, and 7.

Referring to FIG. 9, in operation 910, the electronic device 101 may obtain an input 405 for selecting an image object 310. In an embodiment, the electronic device 101 may obtain a tap input 405 to the image object 310. In an embodiment, the electronic device 101 may obtain the input (e.g., the tap input) 405 to the image object 310 related to an application 420 being executed in a background. In an embodiment, the electronic device 101 may obtain the input (e.g., the tab input) 405 to the image object 310 related to the application 420 most recently executed in a foreground among one or more applications being executed in the background.

In operation 920, the electronic device 101 may identify a priority between screens. In an embodiment, the priority may be set based on the number of inputs required for changing a screen to one or more screens 411, 413, and 416 related to control of a function being executed through the application 420. For example, as the number of the inputs required is higher, the priority of the screen may be higher. However, it is not limited thereto. For example, the priority may be set based on a type of a screen and the number of the inputs required for changing the screen to the one or more screens 411, 413, and 416 related to the control of the function being executed through the application 420. For example, the priority of a screen in which the number of required inputs is greater than or equal to a reference number may be higher than the priority of a screen in which the number of required inputs is less than the reference number. For example, in a case of screens in which the number of required inputs is greater than or equal to the reference number, the priority of a designated type of a screen may be higher than a priority of a screen of a type other than the designated type. The designated type of the screen may include a widget screen 413 for the application 420. The designated type of the screen may include a screen set to be displayed on the second display 235. However, it is not limited thereto. For example, the designated type of the screen may include the application screen 416.

In operation 930, the electronic device 101 may change to a screen having a high priority.

In an embodiment, the electronic device 101 may identify the screen to be displayed on the second display 235, based on the number of the inputs required for changing the screen to the one or more screens 411, 413, and 416 related to the control of the function being executed through the application 420. According to an embodiment, the number of the inputs required for changing the screen from the cover screen 301 may also be referred to as a distance from the cover screen 301.

In an embodiment, the electronic device 101 may identify the screens 413 and 416 among the one or more screens 411, 413, and 416 in which the input required to be changed from the cover screen 301 is required greater than or equal to the reference number (e.g., twice). In an embodiment, the electronic device 101 may identify the screens 413 and 416 not adjacent to the cover screen 301 among the one or more screens 411, 413, and 416. In an embodiment, the electronic device 101 may determine the designated type of the screen among the identified screens 413 and 416 as a screen to be displayed on the second display 235.

In an embodiment, in response to the input (e.g., the tab input) to the image object 310, the electronic device 101 may display, on the second display 235, the screen 413 which is the designated type of the screen among the screens 413 and 416 in which the input required for changing is required greater than or equal to the reference number (e.g., twice). In an embodiment, the electronic device 101 may display, on the second display 235, the screen 413 which is the designated type of the screen among the screens 413 and 416 not adjacent to the cover screen 301, in response to the input (e.g., the tab input) to the image object 310.

In an embodiment, in a case that there is no designated type of the screen among the screens 413 and 416 in which the input required to be changed from the cover screen 301 among the one or more screens 411, 413, and 416 is required greater than or equal to the reference number (e.g., twice), the electronic device 101 may determine a screen of a different type from the designated type as a screen to be displayed on the second display 235. In an embodiment, in a case that there is no designated type of a screen among the screens 413 and 416 not adjacent to the cover screen 301 among the one or more screens 411, 413, and 416, the electronic device 101 may determine a screen of a type different from the designated type as a screen to be displayed on the second display 235. For example, in a case that there is no widget screen 413, the electronic device 101 may determine the application screen 416 as a screen to be displayed on the second display 235.

In an embodiment, in a case that there are no screens 413 and 416 among the one or more screens 411, 413, and 416 in which the input required to be changed from the cover screen 301 is required greater than or equal to the reference number (e.g., twice), the electronic device 101 may determine the screen 411 among the one or more screens 411, 413, and 416 in which the input required to be changed from the cover screen 301 is required less than the reference number (e.g., twice) as a screen to be displayed on the second display 235. In an embodiment, in a case that there are no screens 413 and 416 not adjacent to the cover screen 301 among the one or more screens 411, 413, and 416, the electronic device 101 may determine a screen adjacent to the cover screen 301 among the one or more screens 411, 413, and 416 as a screen to be displayed on the second display 235. For example, in a case that there are no screens 413 and 416, the electronic device 101 may determine the control widget screen 411 as a screen to be displayed on the second display 235.

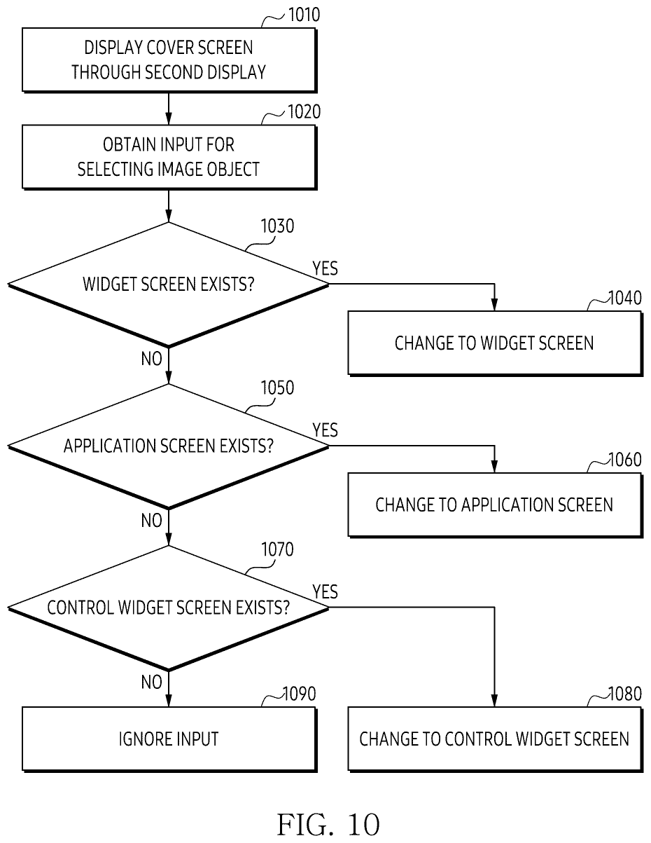

FIG. 10 is a flowchart representing an operation performed by an electronic device, according to an embodiment of the disclosure.

FIG. 10 may be described with reference to FIGS. 1, 2A, 2B, 2C, 3, 4A, 4B, 5A, 5B, 6A, 6B, and 7.

Referring to FIG. 10, in operation 1010, the electronic device 101 may display a cover screen 301 through a second display 235. The electronic device 101 may display the cover screen 301 through the second display 235 in a folded state (e.g., FIG. 2B) and/or an intermediate state (e.g., FIG. 2C) of the electronic device 101. In an embodiment, the cover screen 301 may include an image object 310. In an embodiment, the image object 310 may represent an application being executed in a background. In an embodiment, the image object 310 may display information related to the application being executed in the background. In an embodiment, the image object 310 may also be referred to as a capsule or ongoing activity. In an embodiment, the image object 310 may be related to an application most recently executed in a foreground among one or more applications being executed in the background.

In an embodiment, the electronic device 101 may be changed from an application screen 601 to the cover screen 301 including the image object 310. In an embodiment, the electronic device 101 may display the application screen 601 through a first display 230 while it is in an unfolded state (e.g., FIG. 2A). In an embodiment, as the electronic device 101 transitions from the unfolded state (e.g., FIG. 2A) to the folded state (e.g., FIG. 2B) or the intermediate state (e.g., FIG. 2C), the electronic device 101 may turn off the first display 230 and turn on the second display 235. In an embodiment, as the electronic device 101 is transitioned to the folded state (e.g., FIG. 2B) or the intermediate state (e.g., FIG. 2C), the electronic device 101 may display the cover screen 301 on the turned-on second display 235.

In an embodiment, the electronic device 101 may be changed from screens 411, 412, 413, 414, 415, and 416 to the cover screen 301 including the image object 310. In an embodiment, the electronic device 101 may change a screen displayed through the second display 235 from the screens 411, 412, 413, 414, 415, and 416 to the cover screen 301. For example, the electronic device 101 may change the screen displayed through the second display 235 from the screens 411, 412, 413, 414, 415, and 416 to the cover screen 301, in response to an input (e.g., an input for selection of a home button on a navigation bar). However, it is not limited thereto.

In operation 1020, the electronic device 101 may obtain an input 405 for selecting the image object 310. In an embodiment, the electronic device 101 may obtain a tap input 405 to the image object 310. In an embodiment, the electronic device 101 may obtain the input (e.g., the tap input) 405 to the image object 310 related to an application 420 being executed in the background. In an embodiment, the electronic device 101 may obtain the input (e.g., the tab input) 405 to the image object 310 related to the application 420 most recently executed in the foreground among the one or more applications being executed in the background.

In operation 1030, the electronic device 101 may determine whether a widget screen 413 exists. In an embodiment, the electronic device 101 may determine whether the widget screen 413 exists on the screens 411, 413, and 416 related to the application 420, in response to the input (e.g., the tab input) to the image object 310.

In operation 1030, based on determining that the widget screen 413 exists, the electronic device 101 may perform an operation 1040. In operation 1030, based on determining that the widget screen 413 does not exist, the electronic device 101 may perform an operation 1050.

In operation 1040, the electronic device 101 may be changed to the widget screen 413. In an embodiment, the electronic device 101 may change the cover screen 301 to the widget screen 413. In an embodiment, the electronic device 101 may display the widget screen 413 instead of the cover screen 301.

In operation 1050, the electronic device 101 may determine whether an application screen 416 exists. In an embodiment, the electronic device 101 may determine whether the application screen 416 exists on the screens 411, 413, and 416 related to the application 420, in response to the input (e.g., the tab input) to the image object 310. In an embodiment, the electronic device 101 may determine whether the application screen 416 exists on the screens 411, 413, and 416 related to the application 420, based on determining that the widget screen 413 does not exist.

In operation 1050, based on determining that the application screen 416 exists, the electronic device 101 may perform an operation 1060. In operation 1050, based on determining that the application screen 416 does not exist, the electronic device 101 may perform an operation 1070.

In operation 1060, the electronic device 101 may be changed to the application screen 416. In an embodiment, the electronic device 101 may change the cover screen 301 to the application screen 416. In an embodiment, the electronic device 101 may display the application screen 416 instead of the cover screen 301.

In operation 1070, the electronic device 101 may determine whether a control widget screen 411 exists. In an embodiment, the electronic device 101 may determine whether the control widget screen 411 exists on the screens 411, 413, and 416 related to the application 420, in response to the input (e.g., the tab input) to the image object 310. In an embodiment, the electronic device 101 may determine whether the control widget screen 411 exists on the screens 411, 413, and 416 related to the application 420, based on determining that the widget screen 413 and the application screen 416 do not exist.

In operation 1070, based on determining that the control widget screen 411 exists, the electronic device 101 may perform an operation 1080. In operation 1070, based on determining that the control widget screen 413 does not exist, the electronic device 101 may perform an operation 1090.

In operation 1080, the electronic device 101 may be changed to the control widget screen 411. In an embodiment, the electronic device 101 may change the cover screen 301 to the control widget screen 411. In an embodiment, the electronic device 101 may display the control widget screen 411 instead of the cover screen 301.

In operation 1090, the electronic device 101 may ignore the input 405. In an embodiment, in a case that there is no control widget screen 411, the electronic device 101 may ignore the input (e.g., the tab input) to the image object 310. Ignoring the input (e.g., the tab input) to the image object 310 may mean not changing from the cover screen 301 to another screen.

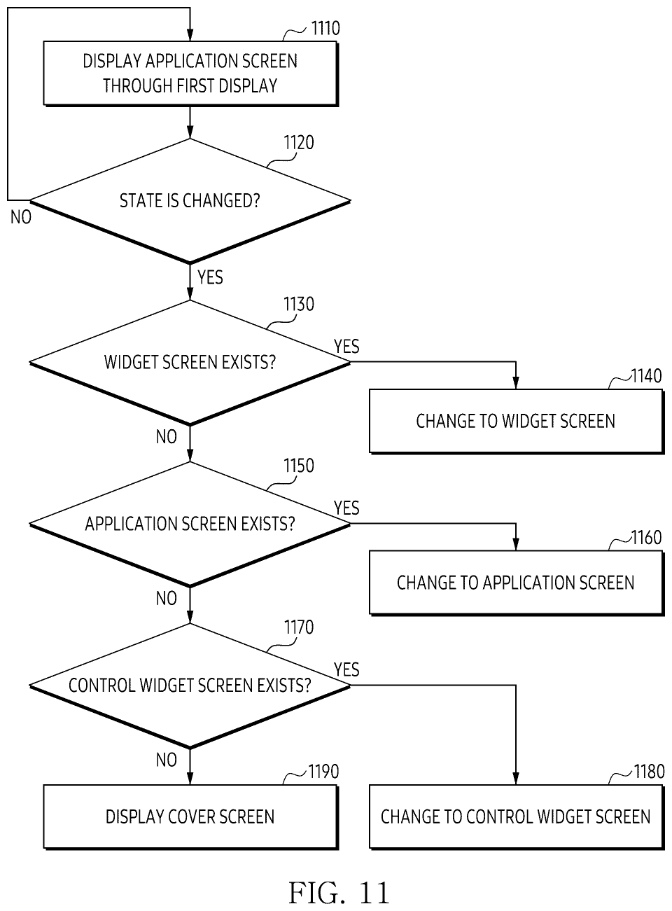

FIG. 11 is a flowchart representing an operation performed by an electronic device, according to an embodiment of the disclosure.

FIG. 11 may be described with reference to FIGS. 1, 2A, 2B, 2C, 3, 4A, 4B, 5A, 5B, 6A, 6B, and 7.

Referring to FIG. 11, in operation 1110, the electronic device 101 may display an application screen 601 through a first display 230. The electronic device 101 may display the application screen 601 of an application 420 through the first display 230 while it is in an unfolded state (e.g., FIG. 2A). The electronic device 101 may display the application screen 601 of the application 420 being executed in a foreground through the first display 230 while it is in the unfolded state (e.g., FIG. 2A).

In operation 1120, the electronic device 101 may determine whether a state is changed. In an embodiment, while displaying the application screen 601 through the first display 230, the electronic device 101 may determine whether the state is changed from the unfolded state (e.g., FIG. 2A) to another state. In an embodiment, while displaying the application screen 601 through the first display 230, the electronic device 101 may determine whether the state is transitioned from the unfolded state (e.g., FIG. 2A) to a folded state (e.g., FIG. 2B) or an intermediate state (e.g., FIG. 2C).

In operation 1120, based on determining that the state is changed, the electronic device 101 may perform an operation 1130. In operation 1120, based on determining that the state does not change, the electronic device 101 may perform the operation 1110 again.

In operation 1130, the electronic device 101 may determine whether a widget screen 413 exists. In an embodiment, the electronic device 101 may determine whether the widget screen 413 exists on screens 411, 413, and 416 related to the application 420, in response that the state of the electronic device 101 is changed.

In operation 1130, based on determining that the widget screen 413 exists, the electronic device 101 may perform an operation 1140. In operation 1130, based on determining that the widget screen 413 does not exist, the electronic device 101 may perform an operation 1150.

In operation 1140, the electronic device 101 may be changed to the widget screen 413. In an embodiment, the electronic device 101 may display the widget screen 413 on a second display 235. In an embodiment, the electronic device 101 may turn off the first display 230 and turn on the second display 235. As the second display 235 is turned on, the electronic device 101 may display the widget screen 413 on the second display 235.

In operation 1150, the electronic device 101 may determine whether an application screen 416 exists. In an embodiment, based on determining that the state is changed, the electronic device 101 may determine whether the application screen 416 exists on the screens 411, 413, and 416 related to the application 420. In an embodiment, the electronic device 101 may determine whether the application screen 416 exists on the screens 411, 413, and 416 related to the application 420, based on determining that the widget screen 413 does not exist.

In operation 1150, based on determining that the application screen 416 exists, the electronic device 101 may perform an operation 1160. In operation 1150, based on determining that the application screen 416 does not exist, the electronic device 101 may perform an operation 1170.

In operation 1160, the electronic device 101 may be changed to the application screen 416. In an embodiment, the electronic device 101 may display the application screen 416 on the second display 235. In an embodiment, the electronic device 101 may turn off the first display 230 and turn on the second display 235. As the second display 235 is turned on, the electronic device 101 may display the application screen 416 on the second display 235.

In operation 1170, the electronic device 101 may determine whether a control widget screen 411 exists. In an embodiment, based on determining that the state is changed, the electronic device 101 may determine whether the control widget screen 411 exists on the screens 411, 413, and 416 related to the application 420. In an embodiment, the electronic device 101 may determine whether the control widget screen 411 exists on the screens 411, 413, and 416 related to the application 420, based on determining that the widget screen 413 and the application screen 416 do not exist.

In operation 1170, based on determining that the control widget screen 411 exists, the electronic device 101 may perform an operation 1180. In operation 1170, based on determining that the control widget screen 411 does not exist, the electronic device 101 may perform an operation 1190.

In operation 1180, the electronic device 101 may be changed to the control widget screen 411. In an embodiment, the electronic device 101 may display the control widget screen 411 on the second display 235. In an embodiment, the electronic device 101 may turn off the first display 230 and turn on the second display 235. As the second display 235 is turned on, the electronic device 101 may display the control widget screen 411 on the second display 235.

In operation 1190, the electronic device 101 may display the cover screen 301. In an embodiment, the electronic device 101 may display the cover screen 301 on the second display 235. In an embodiment, the electronic device 101 may turn off the first display 230 and turn on the second display 235. As the second display 235 is turned on, the electronic device 101 may display the cover screen 301 on the second display 235. For example, in a case that the control widget screen 411, the widget screen 413, and the application screen 416 do not exist, the image object 310 for the application 420 being executing in the background may not be displayed on the cover screen 301.

As described above, an electronic device 101 may comprise a housing including a first housing part 210, and a second housing part 220 which is movably arranged with respect to the first housing part 210. The electronic device 101 may comprise a flexible display 230 bendable according to relative motion of the second housing part 220 with respect to the first housing part 210. The electronic device 101 may comprise a sub display 235 included on a second side opposite to a first side of the first housing part 210 on which the flexible display 230 is included. The electronic device 101 may comprise at least one processor 120 including processing circuitry. The electronic device 101 may comprise memory 130 storing instructions. The instructions, when executed by the at least one processor 120 individually or collectively, may cause the electronic device 101 to display a cover screen 301 including an image object 310 to represent an application 420 being executed in a background through the sub display 235. The instructions, when executed by the at least one processor 120 individually or collectively, may cause the electronic device 101 to, based on receiving an input 405 for selecting the image object 310, identify a first screen 413 which is sequentially changed from the cover screen 301 by another input, and is located at a designated position with respect to the cover screen 301, among one or more screens 411, 413, and 416 for controlling a function being executed through the application 420. The instructions, when executed by the at least one processor 120 individually or collectively, may cause the electronic device 101 to change the cover screen 301 to the first screen 413 based on that the first screen 413 is identified.

The instructions, when executed by the at least one processor 120 individually or collectively, may cause the electronic device 101 to, based on that the first screen 413 is not identified, identify a second screen 411 adjacent to the cover screen 301 among the one or more screens 411, 413, and 416. The instructions, when executed by the at least one processor 120 individually or collectively, may cause the electronic device 101 to change the cover screen 301 to the second screen 411 based on that the second screen 411 is identified.

The instructions, when executed by the at least one processor 120 individually or collectively, may cause the electronic device 101 to obtain the another input 405 for changing a screen of which a type is different from a type of the input 405. The instructions, when executed by the at least one processor 120 individually or collectively, may cause the electronic device 101 to, in response to the another input, change the cover screen 301 to the second screen 411.

In an embodiment, the second screen 411 may be generated when the function is executed in one or more applications 420 of the same type as the application 420 and may be located adjacent to the cover screen 301 when generated. In an embodiment, the first screen 413 may be changed from the cover screen 301 by two or more different inputs for changing the screen and may be located at the designated position regardless of execution of the application 420.

The instructions, when executed by the at least one processor 120 individually or collectively, may cause the electronic device 101 to display the cover screen 301 without the image object 310 on the sub display 235. The instructions, when executed by the at least one processor 120 individually or collectively, may cause the electronic device 101 to execute the application 420 in a foreground. The instructions, when executed by the at least one processor 120 individually or collectively, may cause the electronic device 101 to, while the application 420 is executed in the foreground, obtain another input to display the cover screen 301. The instructions, when executed by the at least one processor 120 individually or collectively, may cause the electronic device 101 to, in response to the another input 405, display the cover screen 301 including the image object 310 to represent the application 420 on the sub display 235.

In an embodiment, the another input may be generated based on a change in a state of the electronic device 101 from an unfolded state to another state distinct from the unfolded state. The instructions, when executed by the at least one processor 120 individually or collectively, may cause the electronic device 101 to, in response to the another input, turn on the sub display 235. The instructions, when executed by the at least one processor 120 individually or collectively, may cause the electronic device 101 to display the cover screen 301 including the image object 310 on the turned-on sub display 235.

In an embodiment, the another input may be an input for changing a screen which is related to the application 420 being executed in the foreground, and is displayed on the sub display 235 to the cover screen 301.

The instructions, when executed by the at least one processor 120 individually or collectively, may cause the electronic device 101 to, based on that the first screen 413 is not identified, identify a third screen 416 representing an execution result of the application 420 among the one or more screens 411, 413, and 416. The instructions, when executed by the at least one processor 120 individually or collectively, may cause the electronic device 101 to change the cover screen 301 to the third screen 416, based on that the third screen 416 is identified.

The instructions, when executed by the at least one processor 120 individually or collectively, may cause the electronic device 101 to obtain the another input 401 for changing a screen of which a type is different from a type of the input 405. The instructions, when executed by the at least one processor 120 individually or collectively, may cause the electronic device 101 to, in response to the another input 401, change the cover screen 301 to an apps screen 415. The instructions, when executed by the at least one processor 120 individually or collectively, may cause the electronic device 101 to, in response to an input 401 for selecting an icon 403 for the application 420 among one or more icons 430 included in the apps screen 415, change the apps screen 415 to the third screen 416.

In an embodiment, the third screen 416 may be a reduced screen from a screen displayed on the flexible display 230 and represents the execution result of the application 420. In an embodiment, the first screen 413 may be displayed only on the sub display 235.

The instructions, when executed by the at least one processor 120 individually or collectively, may cause the electronic device 101 to, in response to that the one or more screens 411, 413, and 416 are not identified, ignore the input 405 for selecting the image object 310.

As described above, a method may be performed in an electronic device 101 including a housing including a first housing part 210, and a second housing part 220 which is movably arranged with respect to the first housing part 210, a flexible display 230 bendable according to relative motion of the second housing part 220 with respect to the first housing part 210, and a sub display 235 included on a second side opposite to a first side of the first housing part 210 on which the flexible display 230 is included. The method may comprise displaying a cover screen 301 including an image object 310 to represent an application 420 executed in a background through the sub display 235. The method may comprise, based on receiving an input 405 for selecting the image object 310, identifying a first screen 413 which is sequentially changed from the cover screen 301 by another input 405, and is located at a designated position with respect to the cover screen 301, among one or more screens 411, 413, and 416 for controlling a function being executed through the application 420. The method may comprise changing the cover screen 301 to the first screen 413 based on that the first screen 413 is identified.

The method may comprise, based on that the first screen 413 is not identified, identifying a second screen 411 adjacent to the cover screen 301 among the one or more screens 411, 413, and 416. The method may comprise changing the cover screen 301 to the second screen 411, based on that the second screen 411 is identified.

The method may comprise obtaining the another input for changing a screen of which a type is different from a type of the input 405. The method may comprise, in response to the another input, changing the cover screen 301 to the second screen 411.

The method may comprise displaying the cover screen 301 without the image object 310 on the sub display 235. The method may comprise executing the application 420 in a foreground. The method may comprise, while the application 420 is executed in the foreground, obtaining another input to display the cover screen 301. The method may comprise, in response to the another input 405, displaying the cover screen 301 including the image object 310 to represent the application 420 on the sub display 235.

In an embodiment, the another input may be generated based on a change in a state of the electronic device 101 from an unfolded state to another state distinct from the unfolded state. The method may comprise, in response to the another input, turning on the sub display 235. The method may comprise displaying the cover screen 301 including the image object 310 on the turned-on sub display 235.

The method may comprise, based on that the first screen 413 is not identified, identifying a third screen 416 representing an execution result of the application 420 among the one or more screens 411, 413, and 416. The method may comprise changing the cover screen 301 to the third screen 416, based on that the third screen 416 is identified.

The method may comprise, in response to that the one or more screens 411, 413, and 416 are not identified, ignoring the input 405 for selecting the image object 310.

As described above, a non-transitory computer readable storage medium may store a program including instructions. The instructions, when executed by a processor 120 of an electronic device 101, including a housing including a first housing part 210, and a second housing part 220 which is movably arranged with respect to the first housing part 210, a flexible display 230 bendable according to relative motion of the second housing part 220 with respect to the first housing part 210, and a sub display 235 included on a second side opposite to a first side of the first housing part 210 on which the flexible display 230 is included, may cause the electronic device 101 to display a cover screen 301 including an image object 310 to represent an application 420 being executed in a background through the sub display 235. The instructions, when executed by the processor 120, may cause the electronic device 101 to, based on receiving an input 405 for selecting the image object 310, identify a first screen 413 which is sequentially changed from the cover screen 301 by another input 405, and is located at a designated position with respect to the cover screen 405, among one or more screens 411, 413, and 416 for controlling a function being executed through the application 420. The instructions, when executed by the processor 120, may cause the electronic device 101 to change the cover screen 301 to the first screen 413 based on that the first screen 413 is identified.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device, comprising:
a housing including a first housing part, and a second housing part which is movably arranged with respect to the first housing part;
a flexible display bendable according to relative motion of the second housing part with respect to the first housing part;
a sub display included on a second side opposite to a first side of the first housing part on which the flexible display is included;
memory storing instructions; and
at least one processor including processing circuitry, the at least one processor communicatively coupled to the flexible display, the sub display and the memory,
wherein the instructions, when executed by the at least one processor individually or collectively, cause the electronic device to:
display a cover screen including an image object to represent an application being executed in a background through the sub display,
based on receiving an input for selecting the image object, identify a first screen which is sequentially changed from the cover screen by another input, and is located at a designated position with respect to the cover screen, among one or more screens for controlling a function being executed through the application, and
change the cover screen to the first screen based on that the first screen is identified.

2. The electronic device of claim 1, wherein the instructions, when executed by the at least one processor individually or collectively, further cause the electronic device to:
based on that the first screen is not identified, identify a second screen adjacent to the cover screen among the one or more screens; and
change the cover screen to the second screen based on that the second screen is identified.

3. The electronic device of claim 2, wherein the instructions, when executed by the at least one processor individually or collectively, further cause the electronic device to:
obtain the another input for changing a screen of which a type is different from a type of the input; and
in response to the another input, change the cover screen to the second screen.

4. The electronic device of claim 2,
wherein the second screen is generated when the function is executed in one or more applications of the same type as the application and is located at a position adjacent to the cover screen when generated, and
wherein the first screen is changed from the cover screen by two or more different inputs for changing the screen, and is located at the designated position regardless of execution of the application.

5. The electronic device of claim 1, wherein the instructions, when executed by the at least one processor individually or collectively, further cause the electronic device to:
display the cover screen without the image object on the sub display;
execute the application in a foreground;
while the application is executed in the foreground, obtain another input to display the cover screen; and
in response to the another input, display the cover screen including the image object to represent the application on the sub display.

6. The electronic device of claim 5,
wherein the another input is generated based on a change in a state of the electronic device from an unfolded state to another state distinct from the unfolded state, and
wherein the instructions, when executed by the at least one processor individually or collectively, further cause the electronic device to:
in response to the another input, turn on the sub display, and
display the cover screen including the image object on the turned-on sub display.

7. The electronic device of claim 5, wherein the another input is an input for changing a screen which is related to the application being executed in the foreground, and is displayed on the sub display to the cover screen.

8. The electronic device of claim 1, wherein the instructions, when executed by the at least one processor individually or collectively, further cause the electronic device to:
based on that the first screen is not identified, identify a third screen representing an execution result of the application among the one or more screens; and
change the cover screen to the third screen, based on that the third screen is identified.

9. The electronic device of claim 8, wherein the instructions, when executed by the at least one processor individually or collectively, further cause the electronic device to:
obtain the another input for changing a screen of which a type is different from a type of the input;
in response to the another input, change the cover screen to an apps screen; and
in response to an input for selecting an icon for the application among one or more icons included in the apps screen, change the apps screen to the third screen.

10. The electronic device of claim 9,
wherein the third screen is a reduced screen from a screen displayed on the flexible display and represents the execution result of the application, and
wherein the first screen is displayed only on the sub display.

11. The electronic device of claim 1, wherein the instructions, when executed by the at least one processor individually or collectively, further cause the electronic device to:
in response to that the one or more screens are not identified, ignore the input for selecting the image object.

12. A method performed by an electronic device including a housing including a first housing part, and a second housing part which is movably arranged with respect to the first housing part, a flexible display bendable according to relative motion of the second housing part with respect to the first housing part, and a sub display included on a second side opposite to a first side of the first housing part on which the flexible display is included, the method comprising:
displaying, by the electronic device, a cover screen including an image object to represent an application being executed in a background through the sub display;
based on receiving an input for selecting the image object, identifying, by the electronic device, a first screen which is sequentially changed from the cover screen by another input, and is located at a designated position with respect to the cover screen, among one or more screens for controlling a function being executed through the application; and
changing, by the electronic device, the cover screen to the first screen based on that the first screen is identified.

13. The method of claim 12, further comprising:
based on that the first screen is not identified, identifying a second screen adjacent to the cover screen among the one or more screens; and
changing the cover screen to the second screen based on that the second screen is identified.

14. The method of claim 13, further comprising:
obtaining the another input for changing a screen of which a type is different from a type of the input; and
in response to the another input, changing the cover screen to the second screen.

15. The method of claim 13,
wherein the second screen is generated when the function is executed in one or more applications of the same type as the application and is located at a position adjacent to the cover screen when generated, and
wherein the first screen is changed from the cover screen by two or more different inputs for changing the screen, and is located at the designated position regardless of execution of the application.

16. The method of claim 12, further comprising:
displaying the cover screen without the image object on the sub display;
executing the application in a foreground;
while the application is executed in the foreground, obtaining another input to display the cover screen; and
in response to the another input, displaying the cover screen including the image object to represent the application on the sub display.

17. The method of claim 16,
wherein the another input is generated based on a change in a state of the electronic device from an unfolded state to another state distinct from the unfolded state, and
wherein the method further comprises:
in response to the another input, turning on the sub display, and
displaying the cover screen including the image object on the turned-on sub display.

18. The method of claim 12, further comprising:
based on that the first screen is not identified, identifying a third screen representing an execution result of the application among the one or more screens; and
changing the cover screen to the third screen, based on that the third screen is identified.

19. The method of claim 12, further comprising:
in response to that the one or more screens are not identified, ignoring the input for selecting the image object.

20. One or more non-transitory computer readable storage media, storing one or more computer programs including computer-executable instructions, that, when executed by one or more processors of an electronic device individually or collectively, cause the electronic device to perform operations, the electronic device including a housing including a first housing part, and a second housing part which is movably arranged with respect to the first housing part, a flexible display bendable according to relative motion of the second housing part with respect to the first housing part, and a sub display included on a second side opposite to a first side of the first housing part on which the flexible display is included, the operations comprising:
displaying, by the electronic device, a cover screen including an image object to represent an application being executed in a background through the sub display,
based on receiving an input for selecting the image object, identifying, by the electronic device, a first screen which is sequentially changed from the cover screen by another input, and is located at a designated position with respect to the cover screen, among one or more screens for controlling a function being executed through the application, and
changing, by the electronic device, the cover screen to the first screen based on that the first screen is identified.
